(19) United States
(12) Patent Application Publication
(10) Pub. No.: US 2003/0226047 A1
(43) Pub. Date: Dec. 4, 2003

(54) Portable terminal with enhanced power management function and method for managing power of the same

(76) Inventors: Keun-Young Park, Seoul (KR); Sung-Soo Lim, Seoul (KR); Chaesang Jung, Seoul (KR)

Correspondence Address: CANTOR COLBURN LLP, 55 Griffin Road South, Bloomfield, CT, 06002, US

(21) Appl. No.: 10/448,728

(22) Filed: May 29, 2003

(30) Foreign Application Priority Data
May 31, 2002 (KR) 2002-30824

(51) Int. Cl. G06F 1/26

(52) U.S. Cl. 713/300

(57) ABSTRACT

A portable terminal with an enhanced power management function and a method for managing power of the portable terminal are provided. The portable terminal includes a setup unit for storing and managing information on a operation condition of each of hardware devices, an execution condition of each of application programs, and a minimum workload state of a running application programs, determining a power mode adequate to each of the hardware devices or a CPU clock speed adequate to the running application program based on the stored information, and providing information on the determination; and a control unit for receiving the determination information from the setup unit and controlling the CPU clock speed to a demanded level or switching each of the hardware devices to a demanded power mode based on the determination information. A hardware device of the terminal can be switched to a low power mode when the device is not used and a CPU clock speed of the terminal can be automatically lowered when an execution speed of an application program is not critical to a user. Therefore, the power consumption of the terminal can be reduced while the performance thereof can be improved.

### BACKGROUND OF THE INVENTION

1. Field of the Invention

The present invention relates to a portable terminal with an enhanced power management function and a method for managing power of the portable terminal. Particularly, the present invention relates to a power management system for effectively managing power of a portable terminal, such as a personal data assistant (PDA), without deteriorating the performance of the terminal or causing any inconvenience to a user while the terminal is being used.

2. Description of the Related Art

Power of a computer system or a computer application apparatus, such as a portable terminal like a PDA, is typically managed by any one of the following methods.

First, in a case where any of internal or external devices, such as a floppy disc drive and a hard disc drive, or peripheral devices, such as a display monitor, of a computer system is not used for a certain time, a power-saving mode of such unused device is enabled to reduce power consumption.

Second, in a case where a user does not access a computer system for a certain time, a hardware mechanism of the system enables a CPU (Central Processing Unit) to enter a power-saving mode to save power.

Third, in a case where a CPU clock speed of a computer system is adjustable, a user may control power of the system by manually adjusting the clock speed.

In the method of controlling power of a computer system by adjusting a CPU clock speed, if a user lowers the CPU clock speed, the power consumption of the system can be reduced. However, if the CPU clock speed is excessively lowered, the performance of the system, e.g. an execution speed of an application program, can be deteriorated. Accordingly, a user may not be satisfied with the performance of the system. On the other hand, if the CPU clock speed is raised too high, the power consumption of the system is also raised while the performance of the system is satisfactory to the user. That is, it is difficult to fulfill the high performance of the system and the effective power management thereof at the same time.

The present invention has been made to solve the above problem, particularly in the field of portable computer application apparatuses like portable terminals, while taking advantages of the conventional methods. Specifically, the present invention is to provide a portable terminal with an enhanced power management function and a method for effectively managing power of the portable terminal. It is a basic concept of the present invention to provide an enhanced power management function of a portable terminal, which can switch a power mode of a hardware device of the terminal to a low power mode when the device is not used and automatically lower a CPU clock speed of the terminal when an execution speed of an application program is not critical to a user.

### SUMMARY OF THE INVENTION

Therefore, an object of the present invention is to provide a portable terminal with an enhanced power management function and a method for effectively managing power of the portable terminal, which can switch a power mode of a hardware devices of the terminal to a low power mode when the device is not used and automatically lower a CPU clock speed of the terminal when an execution speed of an application program is not critical to a user.

Another object of the present invention is to provide a portable terminal with an enhanced power management function and a method for managing power of the portable terminal, which can switch a power of a hardware devices of the terminal to a power-on mode when the device enters a busy state and to a power-saving mode when entering an idle state.

Yet another object of the present invention is to provide a portable terminal with an enhanced power management function and a method for managing power of the portable terminal, which can adjust a CPU clock speed of the terminal to a minimum level when an application program of the terminal enters an idle state and to a maximum level when entering a busy state.

In accordance with an aspect of the present invention, the above and other objects can be accomplished by the provision of a portable terminal with an enhanced power management function, which includes a setup unit for storing and managing information regarding operation conditions of hardware devices, execution conditions of application programs, and a minimum workload status of a running application program, determining a power mode adequate to each of the hardware devices or a CPU clock speed adequate to the running application program based on the stored information, and providing information on the determination; and a control unit for receiving the determination information from the setup unit and controlling the CPU clock speed to a demanded level or switching each of the hardware devices to a demanded power mode based on the determination information.

Preferably, the setup unit may include a first detector for detecting the operation condition of each of the hardware devices based on a signal provided from the corresponding device, a second detector for detecting an execution condition of the running application program based on the signal provided from the corresponding program, a workload reader for reading information on a minimum workload state of each of the application programs, and an environment discriminator for determining a power mode adequate to each of the hardware devices or a CPU clock speed adequate to the running application program and providing information on the determination based on the signals provided from the first detector, the second detector, and the workload reader.

Further, the control unit may include a power mode controller for controlling the power mode of each of the hardware devices and a CPU clock speed controller for controlling the CPU clock speed.

In accordance with another aspect of the present invention, there is provided a method for managing power of a portable terminal with an enhanced power management function, which includes the steps of detecting a variation of a minimum workload state; determining a minimum CPU clock speed when a variation of the minimum workload state has been detected; detecting a variation of each of the hardware devices; switching a power mode of each of the hardware devices when a variation of the corresponding device has been detected; detecting a variation of an execution condition of each of application programs; and adjusting a CPU clock speed when a variation of the execution condition of any application program is detected.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a power management module of a portable terminal with an enhanced power management function according to the present invention;

FIG. 2 is a block diagram of a setup unit used in the power management module shown in FIG. 1;

FIG. 3 is a block diagram of a control unit used in the power management module shown in FIG. 1; and

FIG. 4 is a flow chart of a method for managing power of a portable terminal with an enhanced power management function according to the present invention.

### DESCRIPTION OF THE PREFERRED EMBODIMENTS

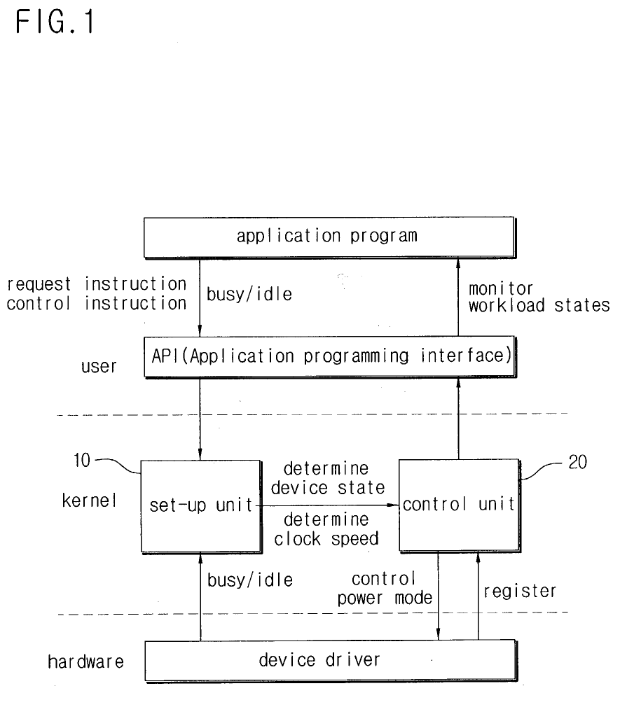

FIG. 1 is a block diagram of a power management module of a portable terminal with an enhanced power management function according to the present invention.

As shown in FIG. 1, the power management module of the portable terminal according to the present invention includes a setup unit 10 and a control unit 20.

The setup unit 10 and the control unit 20 are embodied in a kernel layer. User level application programs and hardware devices of the terminal communicate with each other via an API (Application Program Interface) provided by the setup unit 10 and the control unit 20 to obtain information on a current power state of each of the hardware devices, determine a power management mode, or provide information on the state of each of the application programs to the kernel.

The setup unit 10 determines a power mode of each of the hardware devices or an execution speed of an application program based on the information obtained from a device driver or each of the application programs and provides information on the determination to the control unit 20.

More specifically, the setup unit 10 stores and manages information on an operation condition of each of hardware devices, an execution condition of each of application programs, and a minimum workload state of a running application program. Further, the setup unit 10 determines a power mode adequate to each of the hardware devices or a CPU clock speed adequate to the running application program, and then produces information on the determination.

The control unit 20, in which drivers of the hardware devices are registered, controls or switches a power consumption state of each of registered hardware devices whose power can be controlled.

The control unit 210 controls a CPU clock speed to a demanded level or switches each of the registered hardware devices to a demanded power mode according to the determination information received from the setup unit 10.

As described above, in the power management module of the portable terminal according to the present invention, the setup unit 10 determines a power mode adequate to each of controllable hardware devices or a CPU clock speed adequate to a running application program in accordance with the information on an operation condition of each of the hardware devices, an execution condition of each of the application programs, and a minimum workload state of the running application program and provides the information on the determination to the control unit 20. In accordance with the determination information, the control unit 20 adjusts a CPU clock speed to a demanded level or switches each of the registered hardware devices to a demanded power mode.

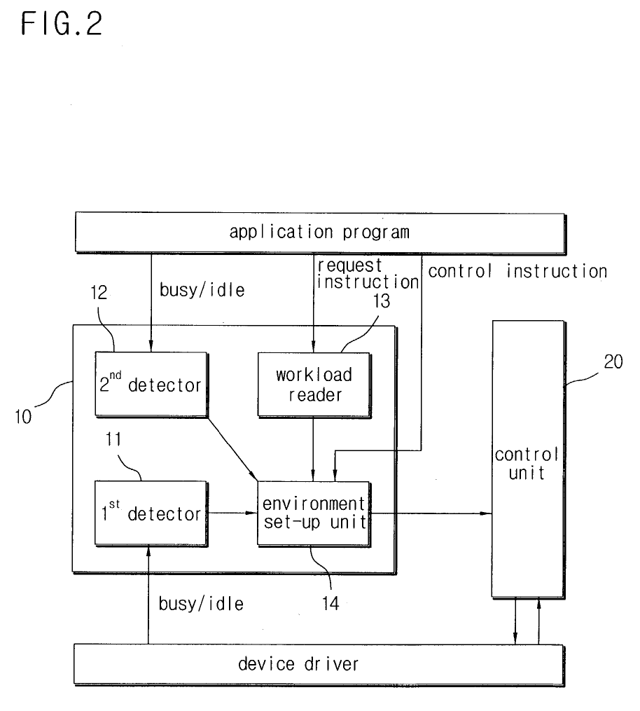

FIG. 2 is a block diagram of a setup unit used in the power management module shown in FIG. 1.

As shown in FIG. 2, the setup unit 10 includes a first detector 11, a second detector 12, a workload reader 13, and an environment discriminator 14.

The first detector 11 detects an operation condition of each of the hardware devices based on a signal provided from the corresponding device.

Whether each of the hardware devices is used, i.e. in a busy state, or not, i.e. in an idle state, can be determined using a device driver. A driver of each hardware device provides a signal to the setup unit 10 when the operation condition of the corresponding device switches between the busy and the idle states so that the first detector 11 of the setup unit 10 detects the operation condition of the corresponding device.

For example, if a sound card outputs a sound signal, the card is in a busy state and, otherwise, is in an idle state.

The second detector 12 detects an execution condition of each of the application programs based on a signal provided from the corresponding application program.

A running application program determines whether a CPU clock speed should be lowered, i.e. an idle state, or not, i.e. a busy state, and informs the determination to the setup unit 10. For example, a program like Windows Manager having a GUI (Graphic User Interface) can detect messages between application programs and can be aware of whether a user inputs an instruction or waits for a response by analyzing such messages. If there is no input from a user or an application program, whose execution speed is not critical, is running, it is detected as an idle state. On the other hand, if there is an input from a user or an execution speed of the running application program is critical to the user, e.g. in a case of redrawing a screen, it is detected as a busy state. When an execution condition is changed as described above, the corresponding application program provides information on the changed condition to the setup unit 10 so that the second detector 12 detects the state of the application program.

The workload reader 13 reads a minimum workload state of each of the application programs.

When a CPU clock speed is lowered, the power consumption can be reduced. However, if the CPU clock speed is lowered below a minimum level, a running application program may not normally operate. For example, in a case of an MP3 player program, at least 50 MHz is required for a normal operation of the MP3 player without sound interruption phenomena. When any application program is running, a minimum workload state of the program is informed to the setup unit 10. A workload state of each application program is a value between 0 and 100, wherein a 0 value means that the program can be executed at a minimum speed without any problem and a 100 value means that the program should be executed at a maximum speed. Whenever the minimum workload state is changed, the application program provides information on the change to the setup unit 10 so that the workload reader 13 detects the minimum workload state of the corresponding application program.

The minimum workload state of an application program is inserted into the corresponding program when a user compiles the program, or is stored in a separate minimum workload state table. The user can be aware of the minimum workload state in advance through simulation of the program or other methods. The minimum workload state inserted in an execution image of the application program is acknowledged by a kernel of an operating system when the application program is loaded by the operating system and inserted into ‘running application program information’ within the kernel.

The environment discriminator 14 determines a power mode adequate to each controllable hardware device or a CPU clock speed adequate to a running application program in accordance with the output signals of the detectors 11 and 12 and the workload reader 13.

Accordingly, the setup unit of the power management module of the portable terminal according to the present invention detects an operation state of each hardware device via the first detector 11, detects an execution condition of each application program via the second detector 12, reads a minimum workload state of a running application program via the workload reader 13 so that the environment discriminator determines a power mode adequate to each controllable hardware device or a CPU clock speed adequate to the running application program in accordance with the detection signals provided from the first and the second detectors 11 and 12 and the workload reader 13 and outputs information on the determination.

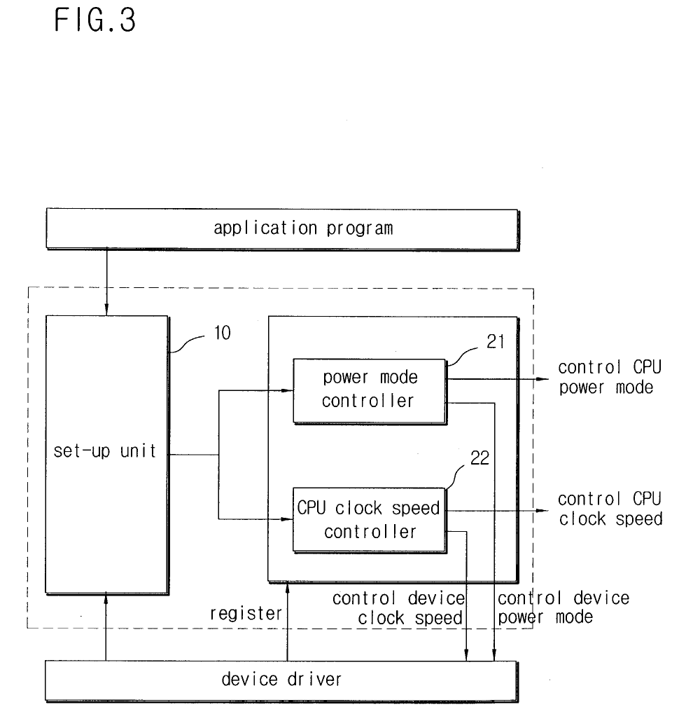

FIG. 3 is a block diagram of a control unit used in the power management module shown in FIG. 1.

As shown in FIG. 3, the control unit 20 includes a power mode controller 21 and a CPU clock speed controller 22.

The power mode controller 21 controls power of each of the hardware devices.

That is, the power mode controller 21 controls a power mode of a hardware device and that of a CPU in accordance with information on power management condition included in a determination signal provided from the setup unit 10.

The CPU clock speed controller 22 controls a CPU clock speed.

Further, the CPU clock speed controller 22 controls timings for accessing a system bus of each hardware device according to the determined CPU clock speed.

That is, the CPU clock speed controller 22 controls a clock speed of the CPU and that of each hardware device in accordance with the clock speed information included in the determination signal provided from the setup unit 10.

Accordingly, the control unit of the power management module of the portable terminal according to the present invention controls the power mode of each hardware device via the power mode controller 21 and the CPU clock speed via the CPU clock speed controller 22 based on the determination signal provided from the setup unit 10.

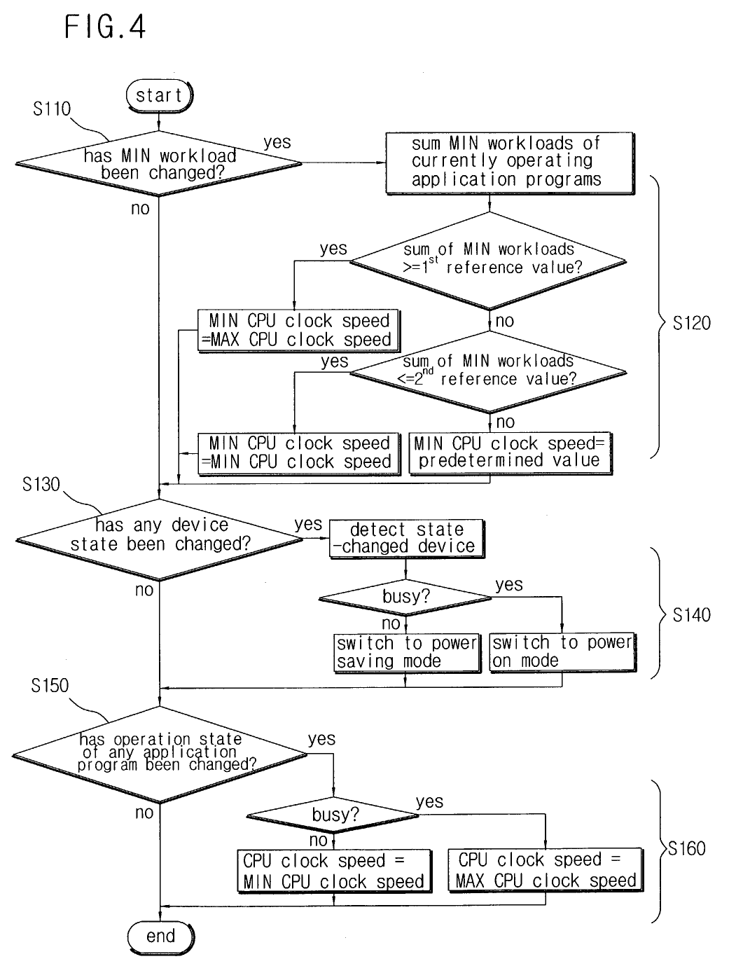

FIG. 4 is a flow chart of a method for managing power of a portable terminal with an enhanced power management function according to the present invention.

In Step S110, a variation of a minimum workload state is detected.

In Step S120, a minimum CPU clock speed is determined, if a variation of the minimum workload state has been detected.

When determining the minimum CPU clock speed in Step 120, if a sum of minimum workload states of each of the running application programs is above a first reference value, preferably 100, the maximum CPU clock speed substitutes for the minimum CPU clock speed. If the sum is below a second reference value, preferably 0, the minimum CPU clock speed substitutes for the minimum CPU clock speed. If the sum is any value between the first and the second reference values, a predetermined value corresponding to that value substitutes for the minimum CPU clock speed.

In Step S130, a variation of an operation condition of each hardware device is detected.

In Step S140, if a variation of an operation condition of any hardware device has been detected, a power mode of the corresponding device is switched.

When switching the power mode of the hardware device whose operation condition has been changed in Step S140, if the device is changed into a busy state, the power mode of the device is switched to a power-on mode. If the device is changed into an idle state, the power of the device is switched to a power-saving mode.

In Step S150, a variation in an execution condition of an application program is detected.

In Step S160, if a variation in an execution condition of an application has been detected, a CPU clock speed is adjusted.

When adjusting the CPU clock speed in Step S160, if the execution condition of the application program is changed into an idle state, the CPU clock speed is adjusted to the minimum CPU clock speed determined in Step S120. If the execution condition of the application program is changed to a busy state, the CPU clock speed is adjusted to the maximum CPU clock speed.

In summary, the method for managing power of a portable terminal with an enhanced power management function according to the present invention includes the steps of detecting a variation of a minimum workload state (Step S110), determining a minimum CPU clock speed when a variation of a minimum workload state has been detected (Step S120), detecting an operation condition of each hardware device (Step S130), switching a power mode of the hardware device whose operation condition has been changed when a variation in an operation condition of the hardware device has been detected (Step S140), detecting a variation of an execution condition of an application program (Step S150), and adjusting a CPU clock speed when a variation in an execution condition of an application program has been detected (Step S160).

Accordingly, the objects of the present invention can be accomplished by the above-described portable terminal with an enhanced power management function and method for managing power of the portable terminal.

As apparent from the above description, there is provided a portable terminal with an enhanced power management function and a method for managing power of the portable terminal according to the present invention, wherein a hardware device of the terminal can be switched to a low power mode when the device is not used and a CPU clock speed of the terminal can be automatically lowered when an execution speed of an application program is not critical to a user. Therefore, the power consumption of the terminal can be reduced while the performance thereof can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A portable terminal with an enhanced power management function, comprising:
a setup unit including a first detector for detecting an operation condition of each of hardware devices based on a signal provided from the corresponding device, a second detector for detecting an execution condition of a running application program based on a signal provided from the corresponding application program, a workload reader for reading information on a minimum workload state of each application program, and an environment discriminator for determining a power mode of a hardware whose power should be controlled or a CPU clock speed required by the running application program and providing information on the determination based on the signals from the first detector, second detector, and the workload reader; and
a control unit including a power mode controller for receiving the determination information from the setup unit and controlling the power mode of each registered hardware device and a CPU clock speed controller for controlling the CPU clock speed based on the determination information.

2. A method for managing power of a portable terminal with an enhanced power management function, comprising the steps of:
a) detecting a variation of a minimum workload state;
b) determining a minimum CPU clock speed when the variation of the minimum workload state has been detected, wherein the minimum CPU clock speed is determined as a maximum CPU clock speed when a sum of minimum workload states of each of application programs is above a first reference value, as a minimum CPU clock speed when the sum is below a second reference value, and as a predetermined value corresponding to the sum when the sum is any value between the first and the second reference values;
c) detecting a variation of an operation condition of each hardware device;
d) switching a power mode of a hardware device to a power-on mode if the operation condition of the hardware device has been changed to a busy state and to a power-saving mode if the operation condition of the hardware device has been changed to an idle state;
e) detecting a variation of an execution condition of an application program; and
f) adjusting a CPU clock speed when a variation of the execution condition of the application program is detected.

3. The method for managing power of a portable terminal as set forth in claim 2, wherein the step f) includes adjusting the CPU clock speed to the minimum CPU clock speed determined in the step b) when the execution condition of the application program is changed to an idle state and to the maximum CPU clock speed when changed to a busy state.
